(19) United States
(12) Patent Application Publication
(10) Pub. No.: US 2013/0183647 A1
(43) Pub. Date: Jul. 18, 2013

(54) System and Method for Managing Information About Playground Installations

(71) Applicant: Playworld Systems, Inc., Lewisburg, PA (US)

(72) Inventors: MATTHEW M. MILLER, Lewisburg, PA (US); RANDAL L. SHROYER, Selinsgrove, PA (US); JENNIFER R. HARRY, Northumberland, PA (US)

(73) Assignee: PLAYWORLD SYSTEMS, INC., Lewisburg, PA (US)

(21) Appl. No.: 13/739,519

(22) Filed: Jan. 11, 2013

Related U.S. Application Data
(60) Provisional application No. 61/586,426, filed on Jan. 13, 2012.

(51) Int. Cl. G09B 5/00

(52) U.S. Cl. CPC G09B 5/00
USPC 434/247

(57) ABSTRACT

An information and management system configured to obtain and provide information about a playground installation may include a readable tag located on or near a playground installation. In response to reading the tag, a user interface of a mobile device may display information such as an identifying description that is specific to the playground installation, a check-in feature enabling a user to notify others of his or her location at the playground installation, instructions for how to use at least one aspect of the playground installation, and a parts list of at least some of the components of the playground installation. The system may further provide a claiming function configured to allow a user to identify a sales order associated with the readable tag with a second user interface, the second user interface configured to further manage the playground installation.

### CROSS-REFERENCE TO RELATED APPLICATIONS

This application claims benefit under 35 U.S.C. §119(e) of Provisional U.S. Patent Application No. 61/586426, filed Jan. 13, 2012, the contents of which is incorporated herein by reference in its entirety.

### BACKGROUND

Mobile or portable devices have become increasingly integral in today's society as a way to provide and obtain information. Users of mobile devices rely on these devices during both working hours and recreational time as their primary means of accessing data and communicating with others. Mobile devices such as smartphones may provide multiple functions such as internet capabilities, email access, calendar functions, software applications, and cellular phone service.

These functions may be useful in providing information regarding places or things near a user's geographical location. For example, a mobile device user at a playground may wish to obtain information about that playground. This user may also want to provide information to others about the user's location. In short, the functionalities of a mobile device may enhance a user's experience at a given location. Despite the potential for an enhanced experience, the complexity of features and volume of information present a challenge for users to access needed functions and data in an efficient way. Due to the size of the user input devices and display screens on mobile devices, it may be difficult for users to enter, retrieve and view information.

A system and method for providing information about a playground installation may enhance a mobile device user's experience by streamlining use of mobile device functions.

### SUMMARY

The following presents a simplified summary in order to provide a basic understanding of some aspects of the claimed subject matter. This summary is not an extensive overview. It is not intended to identify key/critical elements or to delineate the scope of the claimed subject matter. Its sole purpose is to present some concepts in a simplified form as a prelude to the more detailed description that is presented later.

Briefly described, the provided subject matter concerns a system and method for providing and obtaining information about a playground installation. Playground equipment is often designed to fit the particular needs of a particular location. For example, in many playground installations, each piece of equipment is configured of various standardized or customized parts that are put together in unique quantities, colors, and sizes according to the needs of the playground. The system disclosed herein enables a user to obtain instructions on how to use the equipment or tips on activities and enables a user to employ social media or like systems to organize and inform others of the user's arrival at the playground. Additionally, the system enables maintenance or other personnel to obtain specific part number information and bills of materials, such as for ordering parts, and installation and maintenance instructions for specific parts. The system also enables users to find contact information, such as for the manufacturer, retailer, or the like. The inventors are not aware of another system that provides each of these capabilities.

The system disclosed herein is intended for use in conjunction with a mobile device, such as a smart phone or personal digital assistant (PDA), etc. Alternatively, it will be appreciated that the system and method may be used in conjunction with other computer-based systems.

In some embodiments, an information system may be configured to provide information about a playground installation. The system may comprise a readable tag located on or near a playground installation and information accessible on a user interface of a mobile device in response to the mobile device reading the tag. The information may include an identifying description that is specific to the playground installation, a check-in feature enabling a user to notify others of his or her location at the playground installation, and instructions for how to use at least one aspect of the playground installation.

In some embodiments, a playground management system may be configured to manage a playground installation. The management system may comprise a readable tag located on or near a playground installation and an application accessible on a first user interface of a mobile device in response to the mobile device reading the tag. The application may be configured to display and identifying description that is specific to the playground installation, display a parts list of at least some of the components of the playground installation, and provide a claiming function configured to allow a user to identify a sales order associated with the readable tag with a second user interface, the second user interface configured to further manage the playground installation.

Some embodiments of an information system or playground management system such as those described about may include a computer readable storage medium having stored thereon computer executable instructions for performing acts such as those described by the functionalities of these systems.

To the accomplishment of the foregoing and related ends, certain illustrative aspects of the claimed subject matter are described herein in connection with the following description and the annexed drawings. These aspects are indicative of various ways in which the subject matter may be practiced, all of which are intended to be within the scope of the claimed subject matter. Other advantages and novel features may become apparent from the following detailed description when considered in conjunction with the drawings.

### BRIEF DESCRIPTION OF THE DRAWINGS

The following description is better understood when read in conjunction with the appended drawings. For purposes of illustrating the system and method for providing information about playground installations, there is shown in the drawings exemplary constructions of this system and method; however, the system and method is not limited to the specific methods and instrumentalities disclosed. In the drawings:

FIG. 1 is a schematic of a method for accessing information via a 2D barcode;

FIG. 2 is a schematic of an exemplary embodiment of an information system for providing information about a playground installation including a 2D barcode and a user interface;

FIG. 3 is an exemplary display of the 2D barcode depicted in FIG. 2;

FIG. 4 is an exemplary display depicting an opening page of the embodiment of the user interface depicted in FIG. 2;

FIG. 5 is an exemplary display depicting an opening page of a playground user section of the embodiment of the user interface depicted in FIGS. 2 and 4;

FIG. 6 is an exemplary display depicting a page of the embodiment of the user interface depicted in FIGS. 2, 4, and 5 that appears when the play tip icon shown in FIG. 5 is selected;

FIG. 7 is an exemplary display depicting a page of the embodiment of the user interface depicted in FIGS. 2, 4-6 that appears when the check-in icon shown in FIG. 5 is selected;

FIG. 8 is an exemplary display depicting a page of the embodiment of the user interface depicted in FIGS. 2, 4-7 that appears when the play opportunities icon shown in FIG. 5 is selected;

FIG. 9 is an exemplary display depicting a page of the embodiment of the user interface depicted in FIGS. 2, 4-8 that appears when the about this play space icon shown in FIG. 5 is selected;

FIG. 10 is an exemplary display depicting a page of the embodiment of the user interface depicted in FIGS. 2, 4-9 that appears when the donate icon shown in FIG. 5 is selected

FIG. 11 is an exemplary display depicting a page of the embodiment of the user interface depicted in FIGS. 2, 4-10 that appears when the contact me icon shown in FIG. 10 is selected;

FIG. 12 is an exemplary display depicting a page of the embodiment of the user interface depicted in FIGS. 2, 4-11 that appears when the report a problem icon shown in FIG. 5 is selected;

FIG. 13 is an exemplary display depicting a page of the embodiment of the user interface depicted in FIGS. 2, 4-12 that appears when the catalog request icon shown in FIG. 5 is selected;

FIG. 14 is an exemplary display depicting a page of the embodiment of the user interface depicted in FIGS. 2, 4-13 that appears when the find a dealer icon shown in FIG. 5 is selected;

FIG. 15 is an exemplary display depicting a page of the embodiment of the user interface depicted in FIGS. 2, 4-14 that appears when the playground manufacturer description icon shown in FIG. 5 is selected;

FIG. 16 is an exemplary display depicting an opening page of a playground maintenance section of the embodiment of the user interface depicted in FIGS. 2, 4-15;

FIG. 17 is an exemplary display depicting a page of the embodiment of the user interface depicted in FIGS. 2, 4-16 that appears when the color icon shown in FIG. 16 is selected;

FIG. 18 is an exemplary display depicting a page of the embodiment of the user interface depicted in FIGS. 2, 4-17 that appears when the bill of materials icon shown in FIG. 16 is selected;

FIG. 19 is an exemplary display depicting a page of the embodiment of the user interface depicted in FIGS. 2, 4-18 that appears when the instructions icon shown in FIG. 16 is selected;

FIG. 19b is an exemplary display depicting a page of the embodiment of the user interface depicted in FIGS. 2, 4-18 that shows a manual associated with the playground installation;

FIG. 20 is an exemplary display depicting a page of the embodiment of the user interface depicted in FIGS. 2, 4-19b that appears when the email icon shown in FIGS. 18 and 19 is selected;

FIG. 21 is an exemplary display depicting a page of the embodiment of the user interface depicted in FIGS. 2, 4-20 that appears when the question icon shown in FIGS. 4, 6, 13-19, and 20 is selected;

FIG. 22 is an exemplary display depicting a page of the embodiment of the user interface depicted in FIGS. 2, 4-21 that includes a claim sales order icon;

FIG. 23 is an exemplary display depicting a page of the embodiment of the user interface depicted in FIGS. 2, 4-22 that appears when the claim sales order icon shown in FIG. 22 is selected;

FIG. 24 is an exemplary display depicting a page of the embodiment of the user interface depicted in FIGS. 2, 4-23 that appears when the step one icon shown in FIG. 23 is selected;

FIG. 25 is an exemplary display depicting a page of the embodiment of the user interface depicted in FIGS. 2, 4-24 that appears when the step two icon shown in FIG. 24 is selected;

FIG. 26 is an exemplary display depicting a page of the embodiment of the user interface depicted in FIGS. 2, 4-25 that appears when the step three icon shown in FIG. 25 is selected;

FIG. 27 is an exemplary display depicting a page of an embodiment of a second user interface; and

FIG. 28 is a block diagram of one embodiment of a computer system in which aspects of the disclosed systems and methods may be embodied.

### DETAILED DESCRIPTION OF ILLUSTRATIVE EMBODIMENTS

The various aspects of the subject matter described herein are now described with reference to the annexed drawings, wherein like numerals refer to like or corresponding elements throughout. It should be understood, however, that the drawings and detailed description relating thereto are not intended to limit the claimed subject matter to the particular form disclosed. Rather, the intention is to cover all modifications, equivalents, and alternatives falling within the spirit and scope of the claimed subject matter.

Components described below relate to a computer-related entity, either hardware, a combination of hardware and software, software, or software in execution. For example, components may be, but are not limited to being, a process running on a processor, a processor, an object, an executable instruction, a thread of execution, a program, and/or a computer. By way of illustration, both an application running on a computer and the computer can be a component. One or more components may reside within a process and/or thread of execution and a component may be localized on one computer and/or distributed between two or more computers.

In exemplary configurations, the following description relations to a device 220 that is a mobile wireless device. The device 220 may comprise any appropriate device, examples of which include a desktop computing device, a server computing device, a portable computing device, such as a tablet or laptop, a personal digital assistant (“PDA”), a portable phone (e.g., a cell phone or the like, a smart phone, a video phone), a portable email device, or a combination thereof.

In an example configuration, device 220 comprises a processing portion, a memory portion, an input/output portion, and a device user interface. The processing portion, memory portion, and input/output portion may be coupled together to allow communications therebetween. In various embodiments, the input/output portion comprises a receiver of the computing device, a transmitter of the computing device, or a combination thereof. The input/output portion is capable of receiving and/or providing information pertaining to communicate a network such as, for example, the Internet.

The device 220 also can contain a device user interface allowing a user to communicate with the device 220. The device user interface can provide the ability to control the device 220, via, for example, buttons, soft keys, voice actuated controls, a touch screen, movement of the device 220, visual cues (e.g., moving a hand in front of a camera on the device 220), or the like. The device user interface can provide visual information (e.g., via a display), audio information (e.g., via speaker), mechanically (e.g., via a vibrating mechanism), or a combination thereof. In various configurations, the device user interface can comprise a display, a touch screen, a keyboard, an accelerometer, a motion detector, a speaker, a microphone, a camera, a tilt sensor, or any combination thereof. The device user interface can comprise means for inputting biometric information, such as, for example, fingerprint information, retinal information, voice information, and/or facial characteristic information. The device 220, such as smart phone or tablet may also communicate with an application store via a network such as, for example, the Internet. The application store may be, for example, a company specific store or an open device specific store. Any of these components may also be operated by an Internet Service Provider (ISP) or other entity on behalf of any of the entities listed above or others.

In addition to or in place of standard architecture, a number of other types of communication architectures and/or features may be employed. Such other architectures and/or features may include, for example, any combination of hosted services, cloud services, network-based hosted services, Software as a Service (SaaS), Communications as a Service (CaaS), virtual services, on-demand services, public switched telephone network (PSTN) services and others.

Device 22, along with communication servers, application servers, one or more authentication servers, and database may all communicate via cloud. A cloud may be, for example, a public, private, hybrid or other cloud. A cloud may include any number of networks and sub-networks. A public switched telephone network (PSTN) may also be employed in conjunction with the cloud. Devices such as gateways, switches, routers and other components may be employed to direct communications through a cloud. A cloud may be beneficial for enabling efficient communication with servers, databases and other components or operations spread throughout various different national, international and/or global locations.

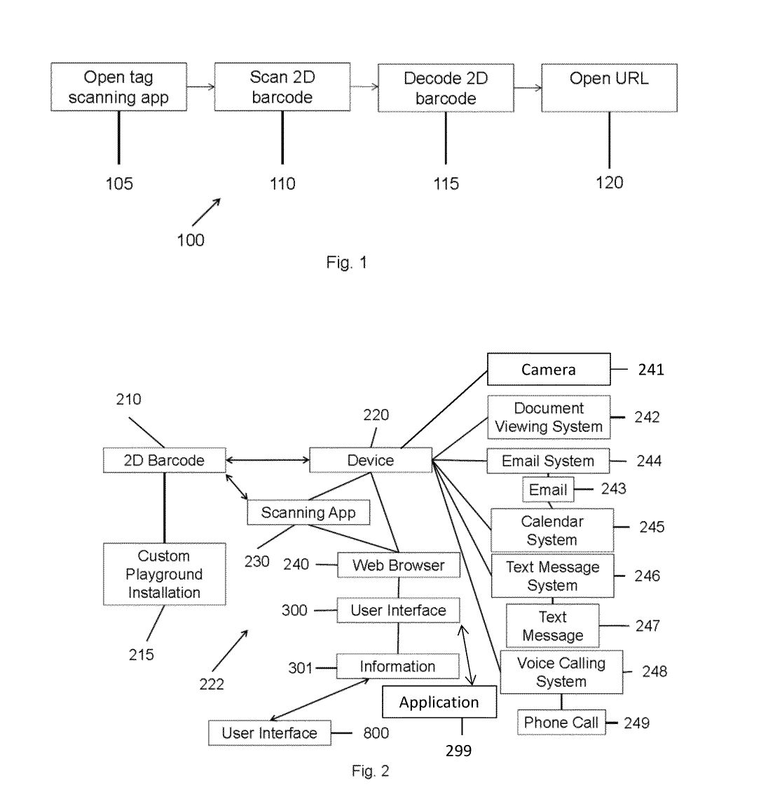

Referring now to FIG. 1, a schematic is shown for a method 100 of accessing information via a computer readable tag. In the first step 105, a user with a device capable of scanning 2D barcodes opens a tag scanning app on the device. In one embodiment, the user may have a smart phone or other mobile device 220 with a camera 241 that is configured to work in conjunction with software installed on the phone or device to read a mobile tag such as a Microsoft Tag. Alternatively, the user may use another device or devices to read a Microsoft Tag or other types of 2D barcodes such as a QR Code or Data Matrix. In some embodiments, the device or devices used in method 100 may include a mobile device such as a PDA, text messenger, cellular phone, pocket personal computer, ultra-mobile tablet PC and the like. In a second step 110, the user may scan the 2D barcode by selecting a scan button in the tag scanning app. In other embodiments, some devices may be configured to require that a user take a picture of the 2D barcode. Alternative embodiments may be configured to automatically scan a 2D barcode without requiring a user to open an app as shown at the first step 105 or press a scan button or to take a picture as shown at the second step 110 or both. In a third step 115, the device decodes the 2D code. In a fourth step 120, the device opens a URL encoded in the 2D barcode. In one embodiment, the fourth step occurs after the decoding step 115 results in a signal being sent to a web browser on the device to open the URL.

In other embodiments, the method 100 may also or alternatively include downloading a second app or offering the user the option of downloading an app. Other embodiments may also or alternatively include automatically opening a video or offering the user the option of viewing a video. Yet other embodiments may also include automatically adding contact information to an address book on or connected to the device or automatically dialing a phone number or offering the user options to add contact information, dial a phone number, or both.

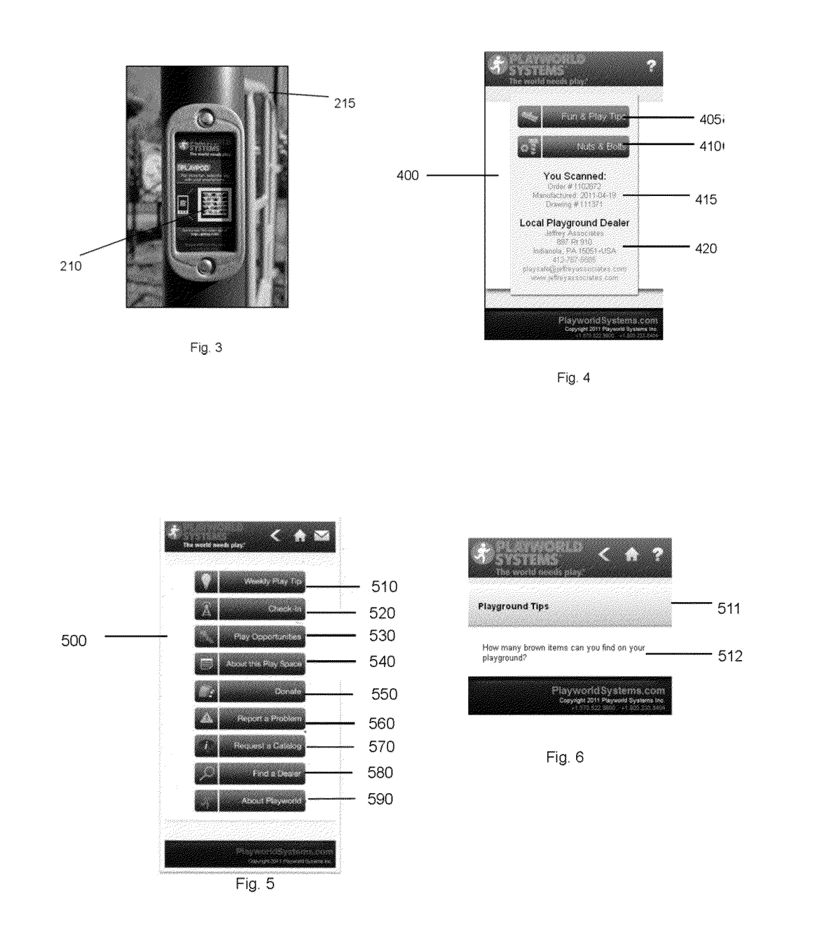

Referring now to FIG. 2, a schematic for an exemplary embodiment of an information system 222 for providing information about a playground installation 215, such as a custom playground installation, includes a 2D barcode 210 located on or near the playground installation 215, a device 220 that has a 2D barcode scanning app 230 and a web browser 240 capable of displaying a user interface 300. In addition to a web browser, the device 220 may also include one or more of the following: a document viewing system 242; an email system 244; a calendar system 245; a text message system 246; and a voice calling system 248. As shown and described in relation to FIG. 1, a user may first open the 2D barcode scanning app 230 on the user's device 220, such as a smartphone. The user may then use the device 220 to scan the 2D barcode 210. FIG. 3 shows one embodiment of the 2D barcode 210 which may be a Microsoft Tag that is located on or near a playground installation 215. Referring again to FIG. 1, the device 220 may decode the 2D barcode. During the decoding process, shown as step three 115 in FIG. 1, a signal may be sent to the web browser 240 on the device 220. The web browser 240 may then open the URL encoded in the 2D barcode and display a user interface 300 of an application 299. The user interface 300 is configured to provide and obtain information 301.

Once the application 299 has been installed onto the device 220, it may communicate with one or more communication servers via a network such as, for example, the Internet. The communication servers may in turn communicate via a firewall with one or more application servers, one or more authentication servers, and a database. Database may be used, for example, to store information regarding features that are made available to the application. Database 28 may also be used, for example, to store information obtained from users of the application 299.

Information 301 provided on the user interface 300 is intended for the use of at least two distinct types of users. The first type encompasses recreational users of the playground installation 215. These recreational users may be parents, guardians, or caregivers that are supervising children's play on the installation. Recreational users also encompass children, themselves, who have access to a device 220, such as a mobile device. The second type of users may be considered playground administrators. Playground administrators may be responsible for managing the playground installation 215. For example, a person who is involved in installing or repairing the installation 215 may be a playground administrator. A person who is coordinates donations that are made to the installation 215 may also be considered a playground administrator. Further, a playground administrator may be a person who otherwise manages administrative aspects of a playground installation, such as creating, updating, and maintaining the content of the information provided on the user interface 300 described herein. In some embodiments, playground administrators may further include manufacturers and/or distributors of the playground installation 215.

An exemplary opening page 400 of the user interface 300 is shown in FIG. 4 and may be used by both recreational users and playground administrators. The embodiment shown includes a playground user section icon 405 and a playground administrator section icon 410. The playground user section, further described below in relation to page 500, may be intended for use by recreational users of the playground installation 215, such as those described above. The playground administrator section, further described below in relation to page 700 may be intended for use by administrators of the playground, such as those described above.

The opening page 400 of the user interface 300 may further include a playground identifying information section 415 and local dealer information section 420. Playground identifying information section 415 may include information specific to the playground installation 215 such as the sales order number for the playground installation 215 (as shown in FIG. 11), the date of manufacture for the playground installation 215, and the drawing number for the playground installation 215. The local dealer information section 420 may include the name, mailing address, phone number, email address, and website of the closest dealer of the brand of playground equipment used in the playground installation 215. Alternatively, the local dealer information 215 may include information for the dealer responsible for the maintenance of the playground installation 215. In other embodiments, the local dealer information may include information for the dealer that sold the playground installation 215.

FIG. 5 shows an exemplary opening page 500 of the playground user section of the user interface 300 and is directed primarily to use by recreational users. In the embodiment depicted in FIG. 4, the playground user section opening page 500 may appear when the playground user section icon 405 is selected on the opening page 400 of the user interface. As shown in FIG. 5, the opening page 500 may include icons for providing and obtaining information relevant to a playground user.

Opening page 500 of the playground user section may include a play tip icon 510. A user may press the play tip icon 510 which may send a signal for the user interface 300 to display a play tip page 511. An exemplary embodiment of the play tip page 511 is shown in FIG. 6. The play tip page 511 may contain a tip 512 for a playground user, such as instructions for how to use at least one part of the playground installation 215. For example, the tip 512 may be a question or puzzle that the playground user can answer or solve by playing on the playground installation 215. The tip 512 may suggest that the user count the number of brown items on the playground installation 215. It will be appreciated that the tip 512 may alternatively suggest other ways to play such as a game of hide-and-go-seek or playing tic-tac-toe using part of the playground installation. The tip 512 may be updated on a regular basis, such as weekly or monthly, so that different tips 512 appear at different times. Maintenance of tip 512 may be done through a second user interface, described below in relation to FIG. 27 by a playground administrator. In other embodiments, maintenance tip 512 may be modified using a separate interface distinct from 300, 800 that is used and controlled by the manufacturer or distributor of the playground installation 215.

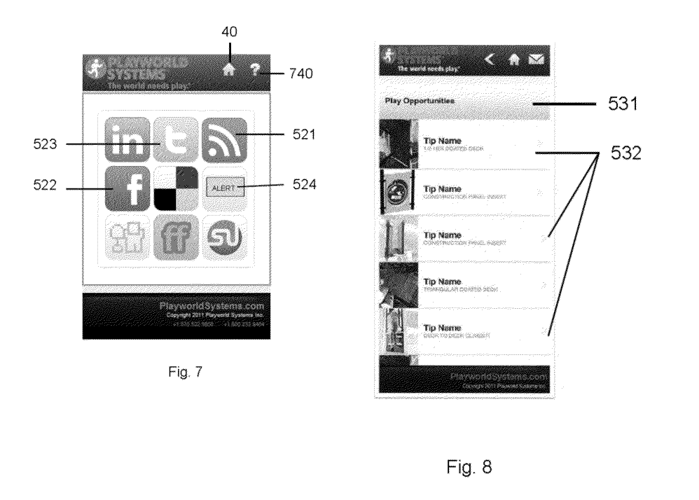

Opening page 500 of the playground user section may include a check-in icon 520. A user may press the check-in icon 520 which may send a signal for the user interface to display a check-in page 521. An exemplary embodiment of the check-in page 521 is shown in FIG. 7. Check-in page 521 may include a variety of icons that provide access to social networks so that the user may alert others that the user is at the playground installation 215. For example, selecting the Facebook™ icon 522 may send a signal to the web browser 240 to update the user's Facebook™ account to indicate the user's presence at the playground installation 215. The user may alternatively or additionally select other icons such a Twitter™ icon 523 to update the user's accounts on that network to indicate the user's presence at the playground installation 215. In alternative embodiments, the check-in page 521 may include an additional alert icon 524 allowing a user to automatically send a text messages 247 or emails 243 using the email system 244 or text message system 246 on the device indicating the user's presence at the playground. Other embodiments may use additional communication systems of the device 220, such as voice calling system 248 to send alerts or messages

In alternative embodiments, the user interface 300 may include additional icons and pages that access other functions on the device 220. For example, the user interface may provide a way for the user to send an email 243 with a calendar invitation on the calendar system 245 of the device 220 to others for times to meet at the playground installation 215. In another embodiment, the user interface 300 may provide access to local emergency contacts in case the user or someone else at the playground installation 215 requires medical attention or the assistance of local police or fire departments. For example, the user interface 300 may send a signal to the voice calling system 248 on the device 220 to call 911.

Opening page 500 of the playground user section may also include a play opportunities icon 530. A user may press the play opportunities icon 530 which may send a signal for the user interface 300 to display a play opportunities page 531. An exemplary embodiment of the play opportunities page 531 is shown in FIG. 8. The play opportunities page 531 may contain play opportunity suggestions 532 for various equipment included in the playground installation 215, such as instructions for how to use at least one part of the playground installation 215. Play opportunity suggestions 532 may be the same as, similar to, or different from the tips 512 described in relation to FIG. 6.

Play opportunity suggestions 532 may be listed on the play opportunities page 531 by the names of the equipment they are associated with as well as, or alternatively to, the names of the respective opportunity suggestions 532. A picture of the respective equipment or activity may also be listed. In some embodiments, a play opportunity suggestion 532 may be instructions for how to use a certain piece of playground equipment on the playground installation 215. For example, the play opportunity suggestion 532 may be instructions for how to use a concave mirror construction panel insert. The suggestion 532 may explain that as the user moves closer to the concave mirror, his or her reflection will flip up-side-down. In some embodiments, when a user presses this opportunity suggestion 532, a description of this may appear on the interface on a separate page. This page may further include links to videos and/or documents that show and/or describe how to use the mirror. These links may further utilize the video and document viewing capabilities of the device 220. The videos and documents found in these links may be controlled and maintained by the manufacturer or distributor of the custom playground equipment 215. Alternatively, a playground administrator may control and maintain these links, for example, through second user interface 800 described below in relation to FIG. 27.

Another opportunity suggestion 532 may be entitled “Raft” and may be intended for use with the triangular coated deck. A picture of the triangular coated deck may also be included on play opportunities page 531. For example, “Raft” may be described as a game where users pretend that the triangular coated deck is a raft floating on water. Yet another example of an opportunity suggestion 532 may be entitled “Frog” and may be intended for use with a deck-to-deck climber. A picture of the deck-to-deck climber may also be included on play opportunities page 531. When a user presses this opportunity suggestion, a description of how to play “Frog” will appear on the interface. For example, “Frog” may be described as a game where users spell a word as they jump on each step to get from one deck to another. So, if there are six steps, a user must spell a six letter word, one for each step.

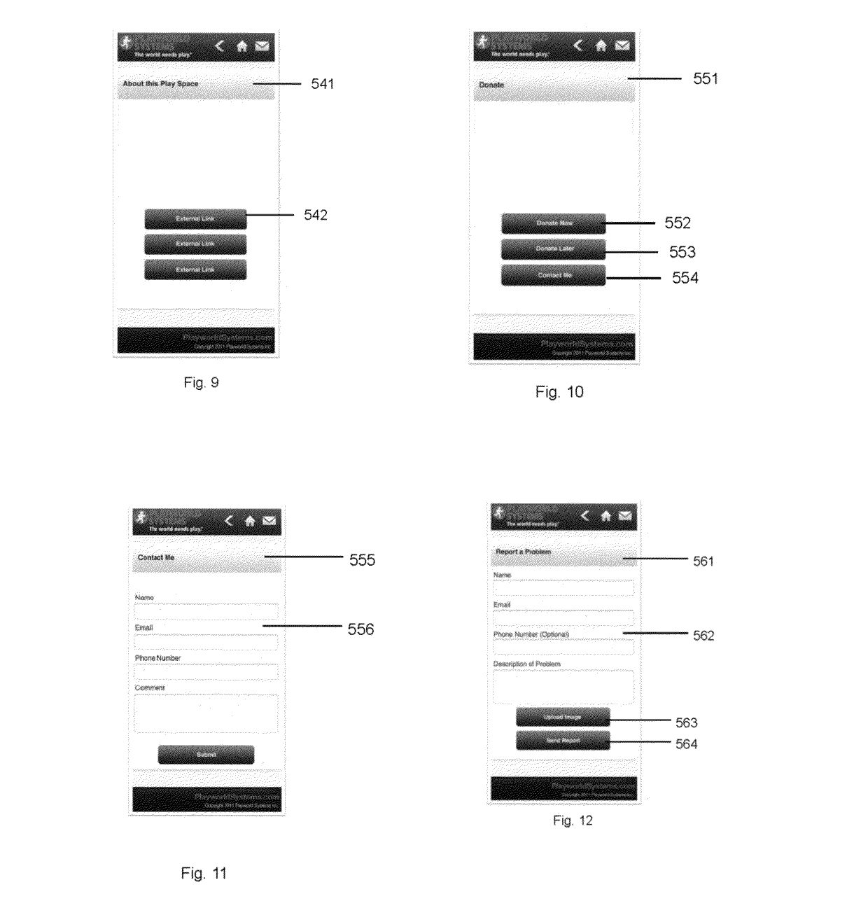

Opening page 500 of the playground user section may also include an about this play space icon 540. A user may press the about icon 540 which may send a signal for the user interface 300 to display an about this play space page 541. An exemplary embodiment of the about this play space page 541 is shown in FIG. 9. The about this play space page 541 may contain information (not shown) about the playground installation 215. For example, this information may include a welcome message to playground visitors, general information about the playground, or a description of external links 542 listed on the page 541. These external link icons 542 may send a signal to open a web browser on the device 220 to show a pre-programmed website. For example, external link icon 542 the device may be prompted to open a browser to view a website that has a video of the dedication of the playground installation. Alternatively, link icon 542 may include the hours that the playground installation 215 is available for play. Information and external links displayed on page 541 may be controlled and maintained by a playground administrator through the second user interface 800 described in relation to FIG. 27 below.

Opening page 500 of the playground user section may also include a donate icon 550. A user may press the donate icon 550 which may send a signal for the user interface 300 to display donate page 551. An exemplary embodiment of donate page 551 is shown in FIG. 10. The donate page 551 may contain links to different donation options 552, 553, 554. For example, if a user presses the donate now icon 552, the device may be prompted to open a web browser that allows a user to enter credit card information to make a donation immediately. If a user presses the donate later icon 553, the device may be prompted to later remind the user to donate and, alternatively or in addition to, to open a web browser that allows a user to enter credit card information to make a donation at a later time. If a user presses the contact me icon 554, a contact me page 555 (shown in FIG. 11) may be prompted to appear on the user interface 300. The contact me page 555 may include a form 556 for a user to fill in with personal information. Using a feature on the device 220 such as the web browser 240 or the email system 244, this information may be sent to a person who manages donations for the playground installation 215. In some embodiments, a playground administrator may be able to obtain this information through the second user interface 800 described below in relation to FIG. 27.

Opening page 500 of the playground user section may also include a report a problem icon 560. A user may press the report a problem icon 560 which may send a signal for the user interface 300 to display report a problem page 561. An exemplary embodiment of report a problem page 561 is shown in FIG. 12. If a user encounters a problem at a playground installation 215, such as a broken swing or other safety hazard, the user can enter a description of the problem along with contact information into form 562. Alternatively, the user can also upload an image of the problem, such as a picture taken using camera 241 on the user's device 220 by pressing the upload image icon 563. The user may press the send report icon 564 to upload the report via the device 220. Using a feature on the device 220 such as the web browser 240 or the email system 244, this information may be sent to a person who is responsible for the maintenance of the playground installation, such as a playground administrator. Additionally, a playground administrator may also be able to control whether the report a problem icon 560 appears on the opening page by adjusting settings on the second user interface 800 shown in FIG. 27. Further, any user of the user interface 300 may use the report a problem feature, including a playground administrator. For example, a playground administrator may use the report a problem feature on the user interface 300 to upload a picture of a maintenance issue at the playground installation 215. The playground administrator may then download this picture via the second user interface 800. In some embodiments, the information uploaded using the report a problem page 561 may also be accessible to the playground manufacturer and/or distributer through interface 800 and/or through another user interface. Such functionality may assist the manufacturer and/or distributor in identifying common problems associated with parts playground installations 215.

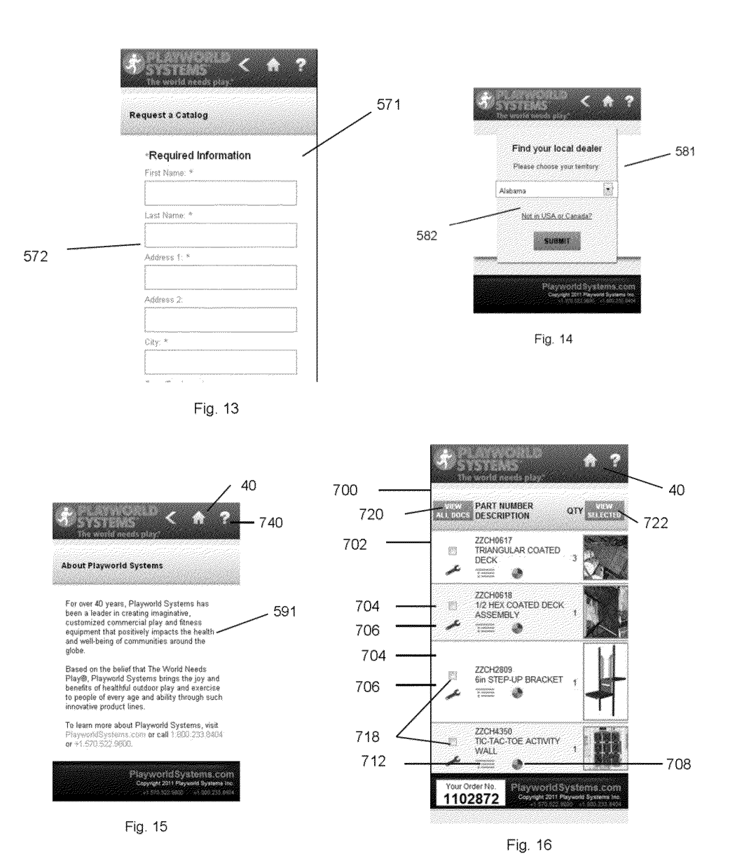

Opening page 500 of the playground user section may also include a catalog request icon 570. A user may press the catalog request icon 570 which may send a signal for the user interface 300 to display a catalog request page 571. An exemplary embodiment of the catalog request page 571 is shown in FIG. 13. The catalog request page 571 may contain a form 572 for a playground user to fill in personal mailing address in order to receive a catalog. Using a feature on the device 220 such as the web browser 240 or the email system 244, this information may be sent to the manufacturer or dealer of the playground installation 215 and/or otherwise made accessible on interface 800 and/or another interface.

Opening page 500 of the playground user section may also include a dealer locator icon 580. A user may press the dealer locator icon 580 which may send a signal for the user interface 300 to display a dealer locator page 581. An exemplary embodiment of the dealer locator page 581 is shown in FIG. 14. The dealer locator page 581 may contain a form 582 for a playground user to select the geographical area, such as a state or territory, in which the user is located. When a geographical area is selected, the user interface 300 may display a list of local dealers within the selected state or territory. This list may provide contact information including contact information including the name, mailing address, telephone number, and email address of any local dealers within a selected geographical area. Information regarding access of the dealer locator page 581 may be made available to the manufacturer and/or distributor through the interface 800 or another interface.

Opening page 500 of the playground user section may also include a playground manufacturer description icon 590. A user may press the playground manufacturer description icon 590 which may send a signal for the user interface 300 to display a description page 591 of the playground manufacturer. An exemplary embodiment of the description page 591 is shown in FIG. 15. For example, the description page 591 may explain the history of the manufacturer or the manufacturer's mission statement.

FIG. 16 shows an exemplary opening page 700 of the administrator section of the user interface 300. The section is intended for use by playground administrators, but in some embodiments, all users have access to this information. In the embodiment depicted in FIG. 4, the administrator section opening page 700 may appear when the playground administrator icon 410 is selected on the opening page 400 of the user interface. As shown in FIG. 16, the opening page 700 may include icons for providing information relevant to a playground administrator. By way of example, a playground administrator may be a person who is installing components of the playground installation 215. In alternative embodiments, a playground administrator user may be a person who performs routine or as-needed maintenance on the playground installation 215.

In some embodiments, user interface 300 may be limited to information in the administrator section described in relation to page 700. In some embodiments, this user interface 300 may be accessible by scanning a 2D barcode 210 located on part of the playground installation 215 prior to installation. This 2D barcode may alternatively be located on packaging material associated with part of the playground installation 215.

Opening page 700 of the playground/installation section may include a parts list 702 with descriptions 704 of parts of the playground installation 215. As shown in FIG. 16, this list 702 may include descriptions 704 of all of the parts in the original shipping order. Each description 704 may include a picture of a given part and indicate a quantity of a given part. Each description 704 may further include parts ordering information 706 such as a part number and a part description for some or all of the parts in the playground installation 215. Information in this section may be maintained by a manufacturer and/or distributor the playground installation.

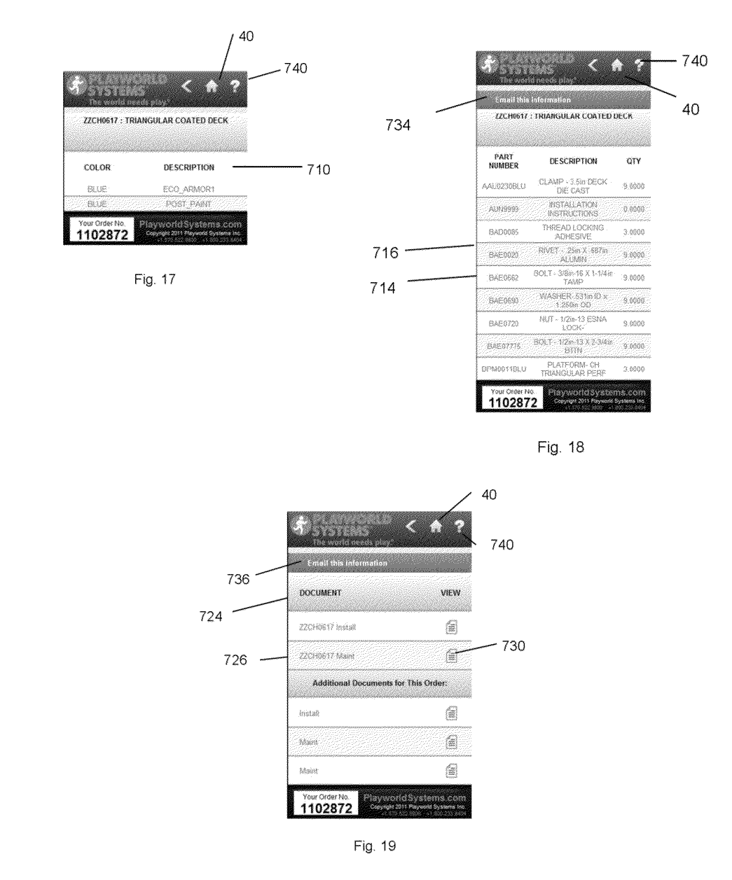

Opening page 700 of the playground maintenance/installation section may include a color icon 708 associated with each description 704 of each part. A user may press the color icon 708 which may send a signal for the user interface 300 to display a color page 710. An exemplary embodiment of the color page 710 is shown in FIG. 17. In the example shown, the color page 710 displays the part name, part number, color number, color description, coating number, and coating description for the part selected.

Opening page 700 of the playground maintenance/installation section may include a bill of materials icon 712 associated with each description 704 of each part. A user may press the bill of materials icon 712 which may send a signal for the user interface 300 to display a bill of materials page 714. An exemplary embodiment of the bill of materials page 714 is shown in FIG. 18. In the example shown, the bill of materials page 714 displays the bill of materials 716 for the part selected which may include the name and number of the part selected as well as the part numbers, part descriptions, and quantities associated with the part selected.

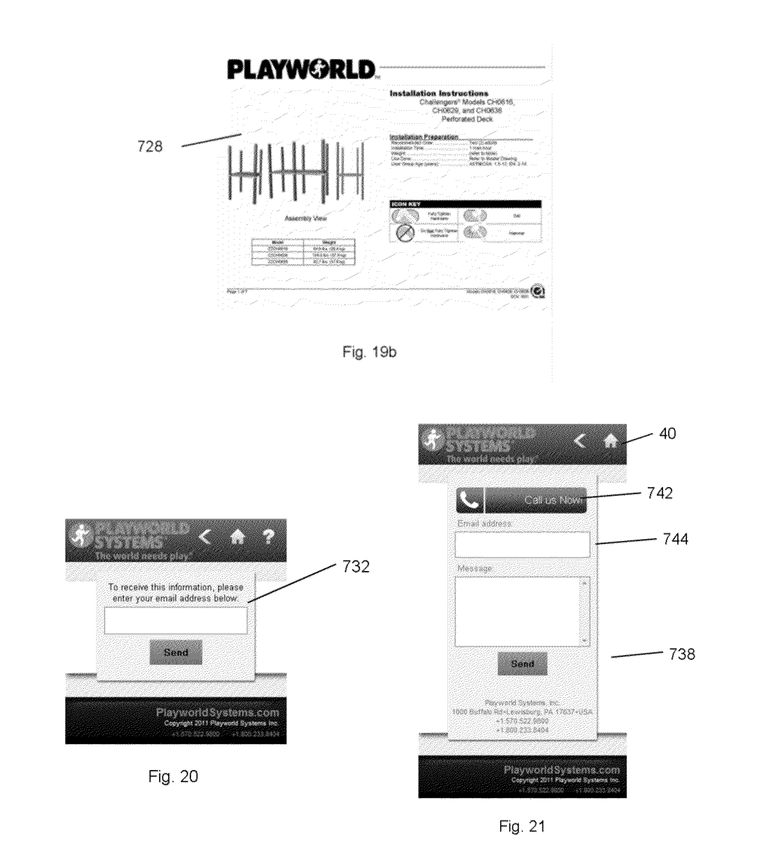

In an exemplary embodiment, in order to view documents associated with a given part or parts, a user may press one or more boxes 718 associated with that part or parts so that a check mark (not shown) appears in the box or boxes 718. The user may then press the view documents icon 720 or the view selected icon 722. When either the view documents icon 720 or the view selected icon 722 is pressed, the user interface 300 may display an instruction page 724. An exemplary embodiment of the instruction page 724 is shown in FIG. 19. In the example shown, the instruction page 724 may display a list 726 of the installation and maintenance manuals 728 associated with the selected part. By selecting a PDF icon 730 for a selected manual 728, the user interface 300 may display the selected manual 728. In one embodiment, the user interface 300 displays the selected manual 728. In another embodiment, the user interface 300 works in conjunction with the document viewing system 242 on the device 220 to display the manual 728. FIG. 19b shows an exemplary embodiment of a manual 728.

Referring now to FIG. 20, an exemplary email entry page 732 is shown. In one embodiment, the user interface 300 may display the email entry page 732 when either email icon 734 shown in FIG. 18, or email icon 736, shown in FIG. 19 is selected. In some embodiments, when email icon 734 (in FIG. 18) is selected, a user may enter an email address in the email entry page 732 so that the bill of materials 716 shown on the page 714 may be sent to the email address provided. In some embodiments, when email icon 736 (in FIG. 19) is selected, a user may enter an email address in the email entry page 732 so that hyperlinks to the manuals 728 shown in the list 726 on instruction page 724 may be sent to the email address provided.

Referring now to FIG. 21, a manufacturer contact page 738 is shown. The user interface 300 may display the manufacturer contact page 738 when a question icon 40, as shown in FIGS. 4, 6, 7, 13-19, and 20 is selected. A telephone icon 742 may be configured to send a signal to the device 220 to call the manufacturer. An email form 744 may be configured to send a signal to the device 220 to send an email to the manufacturer. In one embodiment, the email may contain playground identifying information 415 such as an order number. In another embodiment, the user interface 300 may send a signal to the email system 244 to send an email 243 using a feature on the device 220 such as the web browser 240 or the email system 244.

The pages shown in Figs. may further include a home icon 40. When the home icon 40 is selected, the user interface 300 may display the opening page 400 shown in FIG. 4.

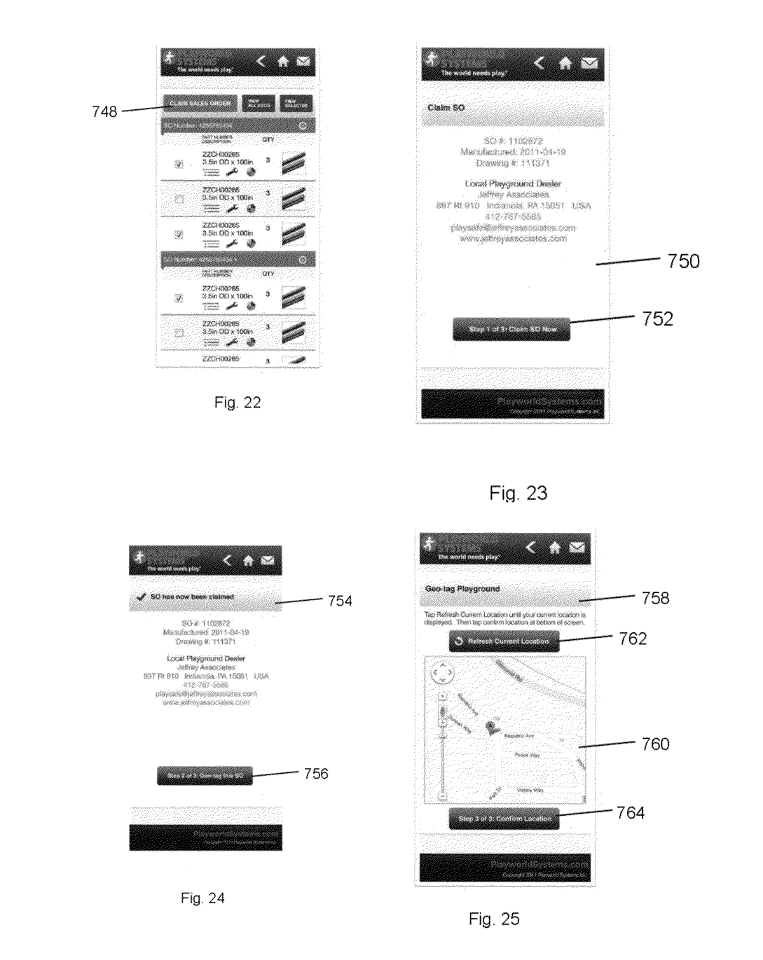

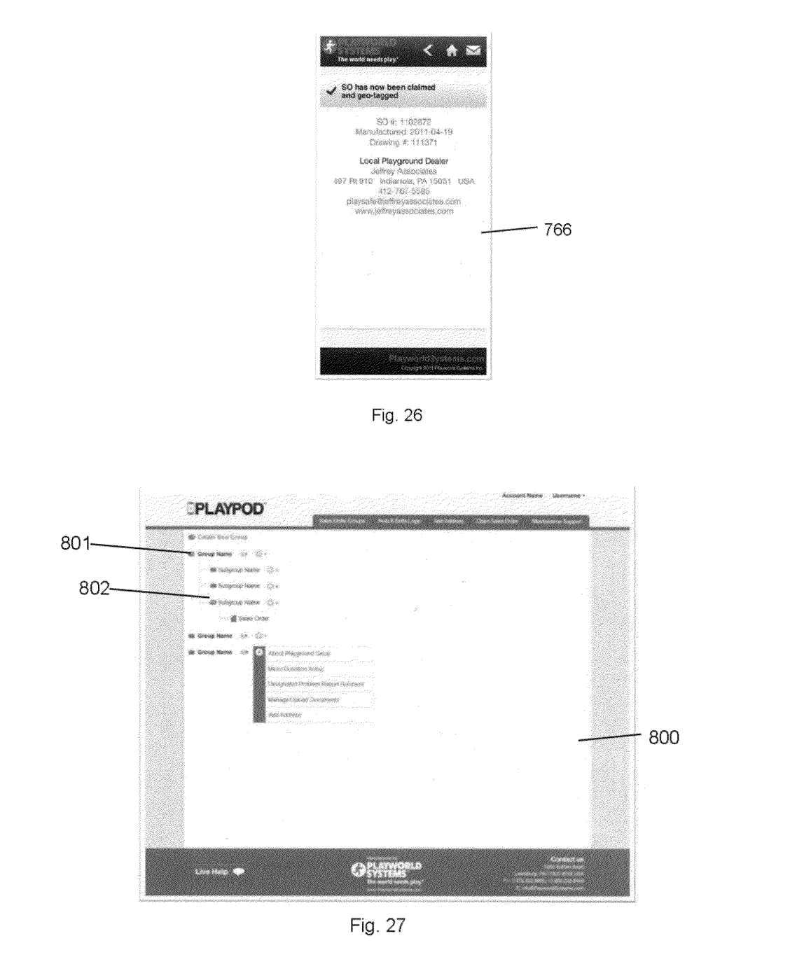

As shown in FIG. 23, the user interface 300 may further include a claim SO page 750. The claim SO page 750 functions to enable a user, such as a playground administrator to “claim” a playground installation 215 by its sales order number. More specifically, a user may press the claim SO icon 748, as shown by way of example in FIG. 22, and the user interface 300 may be prompted to open the claim SO page 750. The user can then verify the information on the page 750 and press the step one icon 752. Page 754 (FIG. 24) may then be generated which indicates to the user that the sales order number associated with the playground installation 215 has been claimed. The user may then chose to press the step two icon 756 which uses the device 220 to geo-tag the location and prompts page 758 to appear on the device 220. Page 758 (FIG. 25) displays a map 760 that shows the recorded geo-tag location. Refresh icon 762 may be used to re-record the geo-tag location. Once the user is satisfied that the geo-tag has been properly recorded, the step three icon 764 may be pressed. Confirmation page 766 (FIG. 26) is then prompted to appear on the user interface 300.

FIG. 27 is an exemplary embodiment of a second user interface 800 that a playground administrator may use in conjunction with the mobile-based user interface 300. The second user interface 800 may be configured to have some or all of the functionality of the mobile-based user interface 300, along with additional functionality and information. The second user interface 800 may be displayed on a desktop, laptop, or tablet computer. Alternatively, second user interface 800 may be displayed on a mobile device, such as a mobile device that is used with user interface 300. Further, user interface 800 may be part of user interface 300.

In some embodiments, user interface 800 may be configured to manage access and viewing capabilities of user interface 300. For example, interface 800 may be used to provide a password protection on the playground administrator icon 410 on the opening page 400 of user interface 300. Password protection may be enabled to prevent the general public from accessing maintenance/installation information about the playground installation.

Second user interface 800 may further function to organize multiple playground installations 215. For example, based on the sales orders of these playground installations 215, the installations 215 may be grouped into groups 801 and subgroups 802. This functionality may assist a maintenance/installation user to manage playground installations based on, for example, geography or maintenance provider.

Second user interface 800 may also provide administrative access to updating or obtaining information from the functionalities of user interface 300. Some embodiments of interface 800 may be configured to provide access to documents tagged when using interface 300 (such as installation or maintenance manuals). Further, second user interface 800 may be used to update and edit the weekly play tip page 511, the play opportunities page 531, the about this play space page 541, and the description page 591. Second user interface 800 may also be used to analyze or obtain information collected from playground users that enter information through the check in page 521, the donate page 551, the report a problem page 561, the request a catalog page 571, and/or the find a dealer page 581. For example, interface 800 may be used to monitor times and volumes of use of the check in page 521 to measure use of the playground installation 215.

The second user interface 800 may also be used to edit and update the play opportunities page 531 and/or the about this play space 541. Features 511, 521, 531, 541, 551, 561, 571, 581, 591 may be managed through a single second user interface 800, or through separate second user interfaces 800 that may be controlled by separate entities. For example, in one embodiment, a playground administrator may manage some of these features, such as the donation page 551 on one user interface 800 while the manufacturer or distributor manages other features, such as the weekly play tip page 511 and play opportunities page 531 on a separate second user interface 800. Further, these features may be managed by a second user interface 800 that is accessible via the first user interface 300.

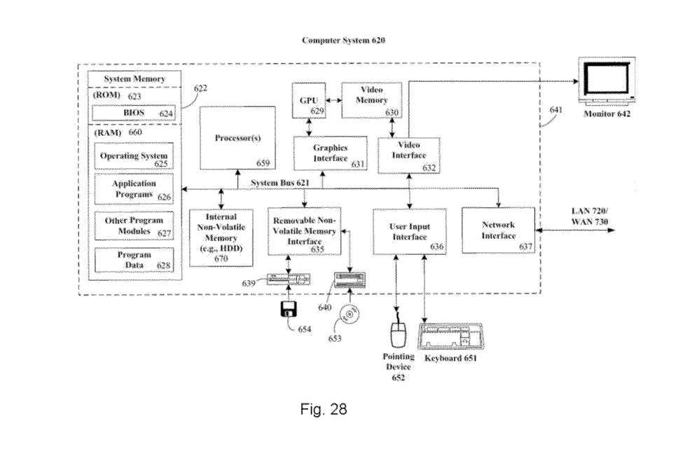

FIG. 28 is a block diagram of an example computer system 620 on which the embodiments described herein and/or various components thereof may be implemented. For example, the functions performed by the entities described in the various embodiments above may be performed by one or more such example computer systems. For example, information system may be implemented in software (i.e., computer executable instructions or program code) executing on one or more such computer systems 620. It is understood, however, that the computer system 620 is just one example of a suitable computing environment and is not intended to suggest any limitation as to the scope of use or functionality of the presently disclosed subject matter. Neither should the computer system 620 be interpreted as having any dependency or requirement relating to any one or combination of components illustrated in FIG. 28. In some embodiments, the various depicted computing elements may include modules or components configured to instantiate specific aspects of the present disclosure. For example, the components used in this description may include specialized hardware components configured to perform function(s) by firmware or switches. In other example embodiments, components may include a general purpose processor, memory, etc., configured by software instructions that embody logic operable to perform function(s). In example embodiments where modules or components include a combination of hardware and software, an implementer may write source code embodying logic and the source code may be compiled into machine readable code that can be processed by the general purpose processor. Since the state of the art has evolved to a point where there is little difference between hardware, software, or a combination of hardware/software, the selection of hardware versus software to effectuate specific functions is a design choice left to an implementer. More specifically, a software process may be transformed into an equivalent hardware structure, and a hardware structure may itself be transformed into an equivalent software process. Thus, the selection of a hardware implementation versus a software implementation is one of design choice and left to the implementer.

In FIG. 28, the computer system 620 comprises a computer 641, which may include a variety of computer readable media. Computer readable media may be available media that may be accessed by computer 641 and may include volatile and/or nonvolatile media, removable and/or non-removable media. The system memory 622 may include computer storage media in the form of volatile and/or nonvolatile memory such as read only memory (ROM) 623 and random access memory (RAM) 660. A basic input/output system 624 (BIOS), containing the basic routines that help to transfer information between elements within computer 641, such as during start-up, may be stored in ROM 623. RAM 660 may contain data and/or program modules that are immediately accessible to and/or presently being operated on by processing unit 659. By way of example, and not limitation, FIG. 28 illustrates operating system 625, application programs 626, other program modules 627, and program data 628. As a further example, video content (e.g. video frames) and/or metadata (e.g. closed caption data), in one embodiment, may be stored in the system memory 622, as well as in any of a variety of non-volatile memory media discussed herein.

The computer 641 may also include other removable/non-removable, volatile/nonvolatile computer storage media. By way of example, the computer 641 may include a hard disk drive 670 that reads from or writes to non-removable, nonvolatile magnetic media, a magnetic disk drive 639 that reads from or writes to a removable, nonvolatile magnetic disk 654, and an optical disk drive 640 that reads from or writes to a removable, nonvolatile optical disk 653 such as a CD ROM or other optical media. Other removable/non-removable, volatile/nonvolatile computer storage media that can be used in the exemplary operating environment include, but are not limited to, magnetic tape cassettes, solid-state drives, flash memory cards, digital versatile disks, digital video tape, solid state RAM, solid state ROM, and the like. Magnetic disk drive 639 and optical disk drive 640 may be connected to the system bus 621 by a removable memory interface, such as interface 635. The drives and their associated computer storage media discussed herein, and illustrated in FIG. 17, may provide storage of computer readable instructions, data structures, program modules and other data for the computer 641.

A user may enter commands and information into the computer 641 through input devices such as a keyboard 651 and/or pointing device 652, commonly referred to as a mouse, trackball, or touch pad. Other input devices (not shown) may include a microphone, joystick, game pad, satellite dish, scanner, or the like. These and other input devices may be connected to the processing unit 659 through a user input interface 636 that is coupled to the system bus, but may be connected by other interface and/or bus structures, such as a parallel port, game port, or a universal serial bus (USB) for example. The computer may connect to a local area network or wide area network, such as LAN 720 and/or WAN 730, through a network interface or adapter 637.

As is apparent from the embodiments described herein, all or portions of the various systems, methods, and aspects of the present invention may be embodied in hardware, software, or a combination of both. When embodied in software, the methods and apparatus of the present invention, or certain aspects or portions thereof, may be embodied in the form of program code (i.e., computer executable instructions). This program code may be stored on a computer-readable storage medium, such as a magnetic, electrical, or optical storage medium, including without limitation a floppy diskette, CD-ROM, CD-RW, DVD-ROM, DVD-RAM, magnetic tape, flash memory, solid-state drive, hard disk drive, or any other machine-readable storage medium, wherein, when the program code is loaded into and executed by a machine, such as a computer or server, the machine becomes an apparatus for practicing the invention. A computer on which the program code executes may include a processor, a storage medium readable by the processor (including volatile and/or non-volatile memory and/or storage elements), at least one input device, and/or at least one output device. The program code may be implemented in a high level procedural or object oriented programming language. Alternatively, the program code may be implemented in an assembly or machine language. In any case, the language may be a compiled or interpreted language. When implemented on a general-purpose processor, the program code may combine with the processor to provide a unique apparatus that operates analogously to specific logic circuits. As used herein, the terms “computer-readable medium” and “computer-readable storage medium” do not include a transient signal.

As the foregoing illustrates, the present invention is directed to systems, methods, and apparatus for to providing information about a playground installation. Changes may be made to the embodiments described above without departing from the broad inventive concepts thereof. Accordingly, the present invention is not limited to the particular embodiments disclosed, but is intended to cover all modifications that are within the spirit and scope of the invention as defined by the appended claims.

What is claimed:

1. An information system configured to provide information about a playground installation, comprising:
a readable tag located on or near a playground installation;
information accessible on a user interface of a mobile device in response to the mobile device reading the tag, the information including:
an identifying description that is specific to the playground installation;
a check-in feature enabling a user to notify others of his or her location at the playground installation; and
instructions for how to use at least one aspect of the playground installation.

2. The system of claim 1 wherein the instructions for how to use at least one aspect of the playground installation includes a tip about how to use at least one aspect of the playground installation.

3. The system of claim 2 wherein the tip is configured to be updated on a weekly basis.

4. The system of claim 1 wherein the instructions for how to use at least one aspect of the playground installation includes a suggestion about how to use at least one aspect of the playground installation.

5. The system of claim 1 wherein the instructions for how to use at least one aspect of the playground installation includes a description of a game that the user can play in conjunction with at least one aspect of the playground installation.

6. The system of claim 1 further configured to utilize at least one feature on the mobile device, wherein the at least one feature comprises at least one of a web browser, a document viewing system, an email system, a calendar system, text message system, or voice calling system.

7. The system of claim 1 wherein the check-in feature is further configured to provide access to at least one social media network to update a status of the user on at least one social media network.

8. The system of claim 1 further comprising a reporting feature configured to allow the user to upload information relating to a maintenance problem at the playground installation.

9. The system of claim 8, wherein the information relating to a maintenance problem at the playground installation includes at least one photograph of the maintenance problem.

10. The system of claim 3 wherein the information system is configured to use at least one of a web browser, an email system, or text message system to manage a donation to the playground installation.

11. A method for providing information about a playground installation comprising:
providing a readable tag located on or near a playground installation;
displaying information on a user interface of a mobile device in response to the mobile device reading the tag, the displaying step further including:
displaying an identifying description that is specific to the playground installation;
displaying a check-in feature enabling a user to notify others of his or her location at the playground installation; and
displaying instructions for how to use at least one aspect of the playground installation.

12. The method of claim 11 wherein the instructions for how to use at least one aspect of the playground installation includes a tip or suggestion about how to use at least one aspect of the playground installation.

13. The method of claim 12 wherein the instructions for how to use at least one aspect of the playground installation includes a description of a game that the user can play in conjunction with at least one aspect of the playground installation.

14. The method of claim 11 wherein the step of displaying information includes utilizing at least one feature comprises at least one of a web browser, a document viewing system, an email system, a calendar system, text message system, or voice calling system.

15. The method of claim 11 wherein the displaying information step further comprises displaying a reporting feature configured to allow the user to upload information relating to a maintenance problem at the playground installation.

16. A playground management system configured to manage a playground installation, comprising:
a readable tag located on or near a playground installation; and
an application accessible on a first user interface of a mobile device in response to the mobile device reading the tag, the application configured to:
display and identifying description that is specific to the playground installation;
display a parts list of at least some of the components of the playground installation; and
provide a claiming function configured to allow a user to identify a sales order associated with the readable tag with a second user interface, the second user interface configured to further manage the playground installation.

17. The management system of claim 16 wherein the first user interface further provides a download feature configured to provide access to at least one installation or maintenance manual.

18. The management system of claim 16 wherein the first user interface is configured to allow a user to geographically tag the playground installation.

19. The management system of claim 16 wherein the user is a first user and wherein the second user interface provides a data management system that displays information collected from at least one second user through a third user interface.

20. The data management system of claim 19 wherein the information collected from the at least one second user includes information about a maintenance problem at the playground installation.
